(19) United States
(12) Patent Application Publication
(10) Pub. No.: US 2012/0116854 A1
(43) Pub. Date: May 10, 2012

(54) Method and system for raising funds using a participant vote based program via a communications network

(76) Inventor: Benjamin Gregory Phipps, Hartford, VT (US)

(21) Appl. No.: 13/135,655

(22) Filed: Jul. 11, 2011

Related U.S. Application Data
(60) Provisional application No. 61/399,450, filed on Jul. 12, 2010.

(51) Int. Cl. G06Q 10/00

(52) U.S. Cl. 705/12

(57) ABSTRACT

A method for raising funds using a participant vote based program via a communications network comprising: a) providing an online program that participants joins; b) providing a program fund where money is added to the fund based on at least one of the following ways: fees paid by participants in the program, fees paid by business related to consumer purchases, fees paid from advertising or related revenue from the program, fees paid by business partners related to participant purchases, contributions from business partners or participants, and contributions from individuals or organizations; c) providing a submission process for a submitter, who request funding; d) providing a voting process where the participant can vote on the submission, and participant can earn and use bonus votes; e) providing a disbursement process where the money is disbursed from the program fund based at least partially on the results of the vote.

### RELATED APPLICATION

This application claims priority to U.S. Provisional Patent Application No. 61/399,450, filed Jul. 12, 2010 entitled “Systems and methods for raising and/or providing funds for charitable and/or non charitable needs using participant vote based programs via a communications network”

### BACKGROUND

Raising funds or money has historically been accomplished in the following general ways:

For business: Loan from a financing institution, through a stock offering privately or publicly, venture capital or through friends and family.

For Charitable Organizations: Ask for donations which is generally accomplished in a letter or email campaign or advertising their needs. Also other event based fundraiser, like raffles, auctions, and dinners.

For Individuals Money raised for individual needs generally include a loan from a financing institution, or through loans or gifts from family or friends.

### SUMMARY OF THE INVENTION

There are many problems with the above funding methods as they may not be an option for many individuals or organizations looking for funding, and these methods may not be the most efficient or effective methods for many individuals and organizations. Also, online options consist of advertising where an individual or organization register with a host web site to ask for donations, or ask for donations on their own website. Typically, this fundraising is for charitable causes. In addition, two large corporations, American Express and Pepsi have web sites using the internet to connect with consumers in their own giving and marketing campaigns. They have marketed a specific dollar amount to be given out to a winning organization or idea. These campaigns are only for charitable organizations requesting money, and have the public or customers vote for a winner of the money. The problems with the American Express and Pepsi form of giving are they are generally limited to charitable organizations and specific causes, funding is limited to the specific amount of generosity of the individual corporation, and only the winner receives funding. The Present Invention aims to solve at least one of these and other problems.

In a preferred embodiment of the present invention, a method and system for raising funds using a participant vote based program via a communications network may comprise: a) creating an online program that more than one participant joins; b) creating a program fund comprising of currency, preferably money, that said currency is added to the fund in a method comprising at least one of the following ways:
1. a portion or percentage or set amount, which can be based on a formula, of membership or non membership fees as paid by participants in the program;
2. a portion or percentage or set amount, which can be based on a formula, of consumer revenue from a specific service or product, and/or total consumer revenue for consumers/participants in the program;
3. a portion or percentage or set amount, which can be based on a formula, of advertising or other media related revenue from program or program operator web site;
4. a portion or percentage or set amount, which can be based on a formula, of participant purchases of goods or services through program business partners;
5. contributions or sponsorships from more than one program business partner or program participant;
6. contributions or sponsorships from more than one organization or individual who can be creators of the program;
c) providing a submission process wherein the participant or a potential participant has the opportunity to become a submitter, who request funding, by providing a submission template for inputting information into an electronic database to create an electronic web page to request funding; d) providing a voting process wherein the participant can vote on the submission(s); e) providing a disbursement process wherein the currency is disbursed from the program fund to the submitter(s) who are selected based at least partially on the results of the vote; f) using a computer readable medium; the computer readable medium is a “non transitory” medium; can be accomplished via communication networks, preferably internet based using internet accessible devices.

In a preferred aspect, the method may further comprise of giving the program participant the opportunity to earn bonus votes which are additional votes; the bonus votes can be used in voting for a submission requesting funding. Further, bonus votes can be earned or given based on any action allowable in the program.

In another preferred aspect, the method may further comprise a voting cycle that can be on a periodic or continuous basis, preferably monthly.

In another preferred aspect, the method may further comprise a program fund disbursement cycle that can be on a periodic or continuous basis, preferably monthly.

In another preferred aspect, the method may further comprise determining money available for disbursement, at least partially, by separating the participant related fee or consumer income that is added to the program fund into time periods where the money or currency is available for disbursement, preferably twelve months.

In another preferred aspect, the method may further comprise of disbursements from the program fund to the selected submitter can be in the form of a grant, loan, debt investment, equity investment, gift or donation and any allowable form of giving or investing money or other forms of currency; disbursement can be made with money or any other form of currency which can consist of goods and services, preferably in money, preferably in U.S. dollars.

In another preferred aspect, the method may further comprise of providing funds for any type of need, request or project; available for any organization or individual need.

In another preferred aspect, the method may further comprise of a system of paying commissions to affiliates.

In another preferred aspect, the method may further comprise of showing a running vote total on the submission's web page or the program operator's web page.

In another preferred aspect, the method may further comprise of allowing program participants to send money or help to the submitter, preferably directly through the submitter's submission page.

In another preferred aspect, the method may further comprise a process of the participant learning how funds are used to help the selected submitter.

The result is the present invention provides a new and unique method of raising funds for any organization or individual financial need which allows more individuals and more organizations access to funding, than what is currently available. And for these individuals and organizations the present invention can provide a more efficient and effective manner in which to raise funds. And for the participant in the program the present invention provides an efficient and effective way of providing financial assistance.

### BRIEF DESCRIPTION OF THE DRAWINGS

FIG. 1 shows a perspective view of the present invention related to how the program is deployed from the application server to be accessible by the public and the participants via internet accessible devices.

FIG. 2 shows a perspective view of the present invention related to the participant paying a membership fee and how the fee is separated to add to program fund.

FIG. 3 shows a perspective view of the present invention related to the submission and voting process and the submitter's request being granted.

FIG. 4 shows a perspective view of the present invention related to the participant's purchase through a business partner adds money to the program fund.

FIG. 5 shows a perspective view of the present invention related to bonus votes.

FIG. 6 shows a perspective view of the present invention related to how consumer purchases can add money to the program fund.

FIG. 7 shows a perspective view of the present invention related to how advertising and related income can be added to the program fund.

FIG. 8 shows a perspective view of the present invention related to how contributions or sponsorships from participants or business partners can add money to the program fund.

FIG. 9 shows a perspective view of the present invention related to how contributions or sponsorships from individuals or organizations can add money to the program fund.

### DETAILED DESCRIPTION OF PREFERRED EMBODIMENTS

The present invention aims to solve the mentioned problems with a general method. The method will be described with respect to at least one possible embodiment. One skilled in the art will recognize that a great many possible embodiments of the present invention exist.

In one embodiment, the present invention includes a method of raising funds or money online using a participant vote program via a communications network.

A participant, which may be any type of entity, individual or organization, and can also be called a member or consumer, joins a program. The program, which can also be called a club, is the structure or designed system created or managed by a program operator with at least one of its purposes to be to raise funds for individuals or organizations. The program operator operates the program that utilizes the present invention. The program operator may be an individual or an organization.

The program has as at least one of its features, a program fund which allows individuals or organizations, participant or non participants the opportunity to raise currency, preferably money for a need they may have. The program fund is a fund or pool of currency wherein money from membership fees, earnings from consumer purchases, contributions, sponsorships, or other means accumulate for the purpose of being distributed. The fund may also comprise of goods or services, the preferable content of the program fund is money or currency. The program fund may be a separate bank account, or may be a separate account for accounting purposes.

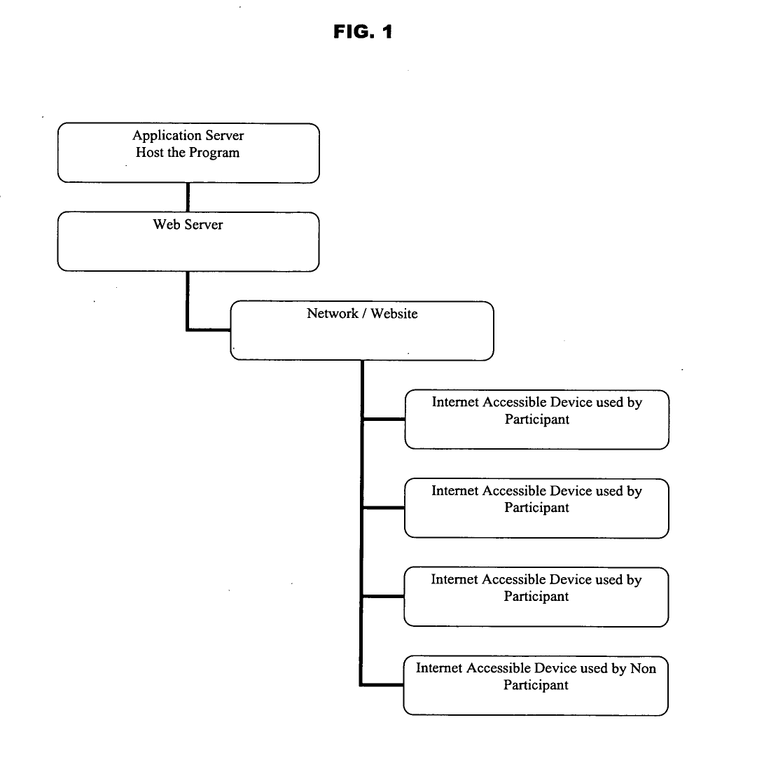

As shown in FIG. 1, the participant joins the program using an internet accessible device which is any electronic device used to access the Internet, including (e.g.), but not limited to, Local Area Networks (LAN's), Wide Area Networks (WAN's), personal computers, telephones, personal digital assistant, mobile devices, or interactive television. An application server can host the program. The participant accesses or communicates with the program using the internet accessible device.

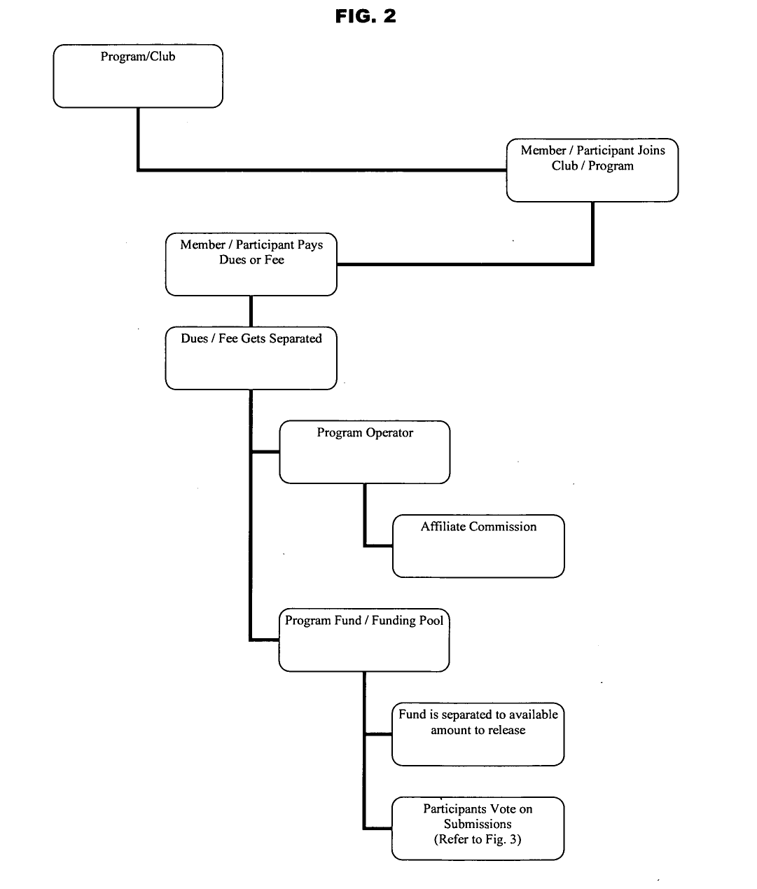

As shown in FIG. 2, the participant pays a membership fee to join the program. Of the membership fee at least a percentage goes to the program fund and the remaining membership fee stays with program operator for its purposes which may include operating expenses.

Further the portions of the membership fee that goes into the fund may be separated, preferably equally, into multiple time periods, preferably twelve months, so that there is money to distribute each month. As an example, $12 of a $19 annual membership fee is placed in to the fund and the program guidelines stipulate that $1 of the $12 will be available each month for disbursement from the fund. In this example, if there were one million members, then each month one million dollars would be available for disbursement each month. If the program does not disburse the full amount available for disbursement that month or voting cycle, the remaining available for disbursement amount can be rolled into the next month or voting cycle.

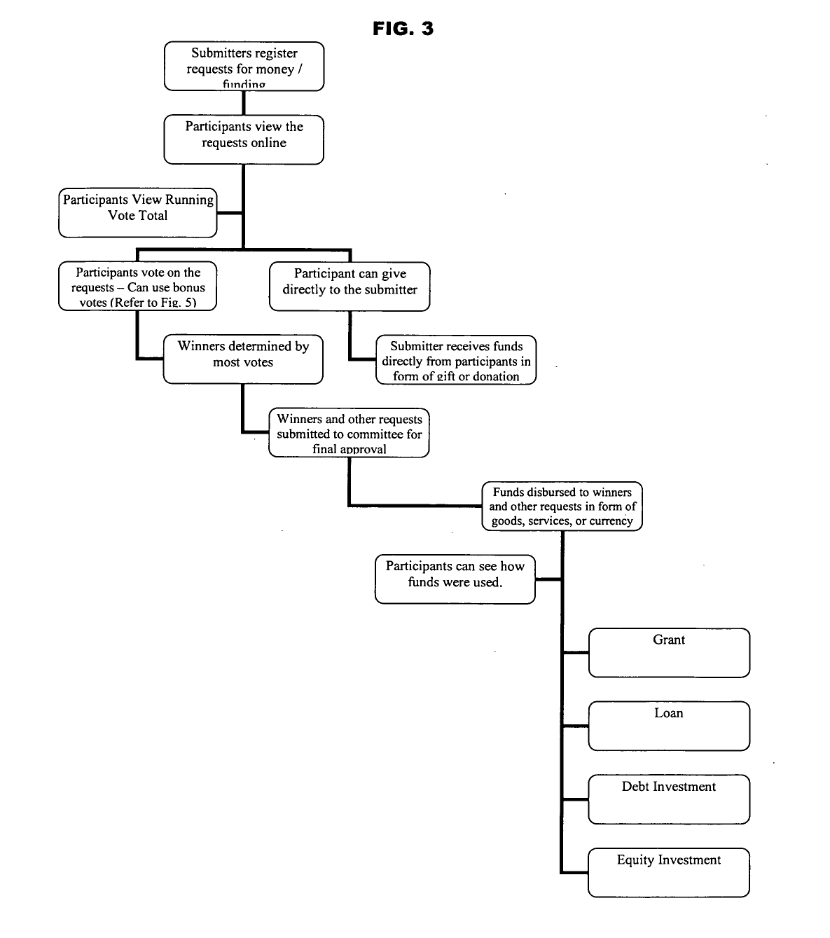

As shown in FIG. 3, the participant has online access to submissions which are request for funding as part of the program. A submitter is an individual(s) or organization(s) that makes a submission to the program via an internet accessible device. Based on a voting cycle, preferably monthly, the participant can vote for a submission. As part of their membership or the program they joined, a participant can receive at least one vote per voting cycle.

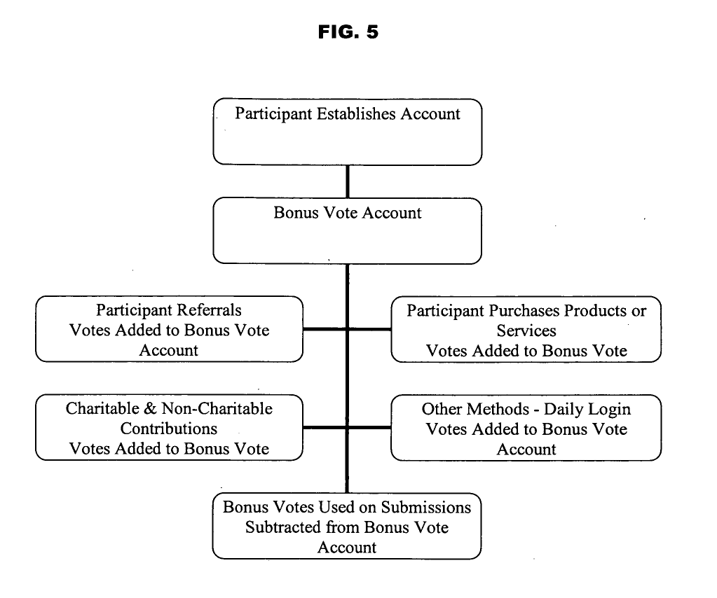

As shown in FIG. 5, the participant also can have the opportunity to establish a vote or points account and earn bonus votes. Bonus votes are additional votes that are earned by a participant through offers from program operator which can be used in voting on submissions for request for funding. Bonus votes can also be called points or any other acceptable name. Example of how bonus votes are earned include but are not limited to at least one of the following: 1) referring a participant to the program, 2) making a donation to a charity or the fund, 3) purchasing an item or service from a program business partner, 4) taking an action on program web site like logging on to program web site or some other action consistent with the program.

The participant or a non participant may earn an affiliate commission (Refer to FIG. 3).

Participants can see a running vote total during the voting cycle (Refer to FIG. 3).

As shown in FIG. 3, after the voting is complete, the winner of the vote can receive funding. Any submitter receiving funding preferably will go through a vetting process. A program may have more than one category from which a winner is chosen. Non winners of the vote may still be eligible to receive funding which can be determined at least partially based on the results of the vote or on a vote by a funding committee.

Funds disbursed to the submitter may be in the form of a grant, loan, equity investment or any other form of giving or investing money allowable (Refer to FIG. 3).

The submitter may also raise funds by having a process for participants to contribute to them directly through the submitter's submission page (Refer to FIG. 3)

The present invention is not limited to the discussed embodiments. Other embodiments and features, such as the ones described below, are within the scope of the present invention.

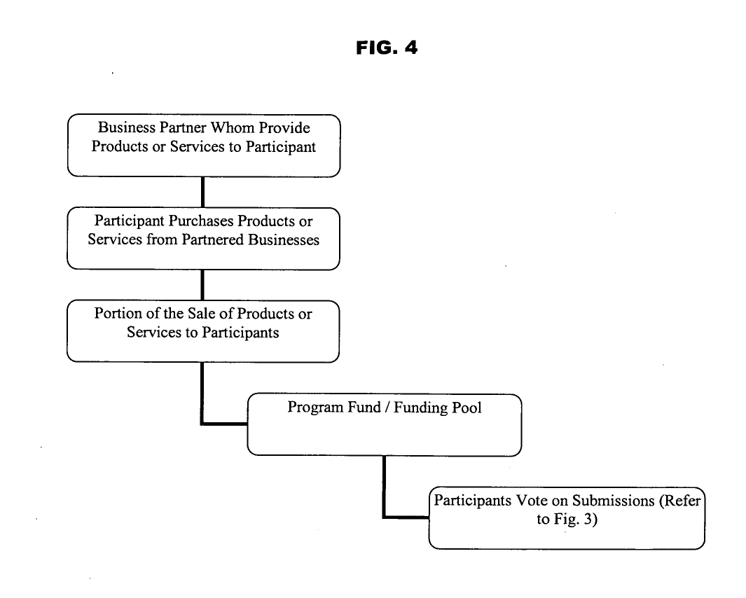

In another embodiment, money can be added to the program fund via a business partner, a business that has made an arrangement with the program operator, which may comprise of the business partner offering their goods or services to the program participants. In one embodiment a business partner may have an arrangement where for every widget a participant purchases the program fund receives $1 and the participant receives five bonus votes. Also, money may be added to program fund through contribution and sponsorship income from a business partner. (Refer to FIG. 4).

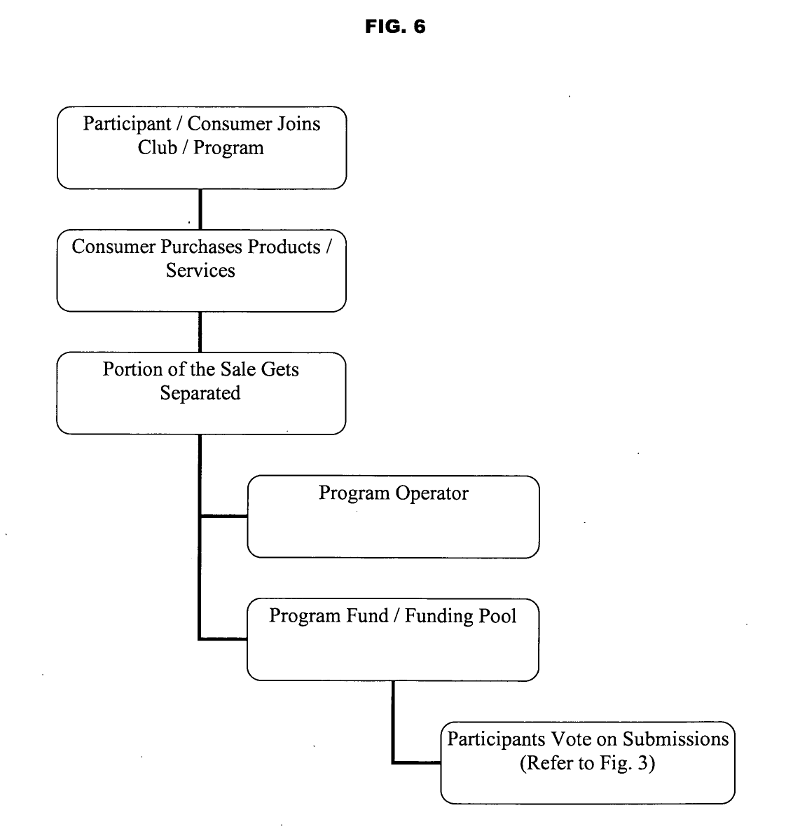

In another embodiment, money can be added to the program fund through a program that has participants that are consumers. An example of this would be the participant joins the program and the program has relationships with at least one business. The participant purchases items or services from the business through the program and a set amount or percentage of each purchase is added to the program fund. (Refer to FIG. 6).

The money added to the fund may be separated into time periods where the money becomes available. The participant may also earn bonus votes on their purchases. Amount added to the program fund related to consumer revenue can also be based on total revenue from a business or some form thereof whether it is related to the program or not. For example, a business can have an agreement with the program where 3% of its revenue each month goes into the program fund regardless of where the revenue is earned.

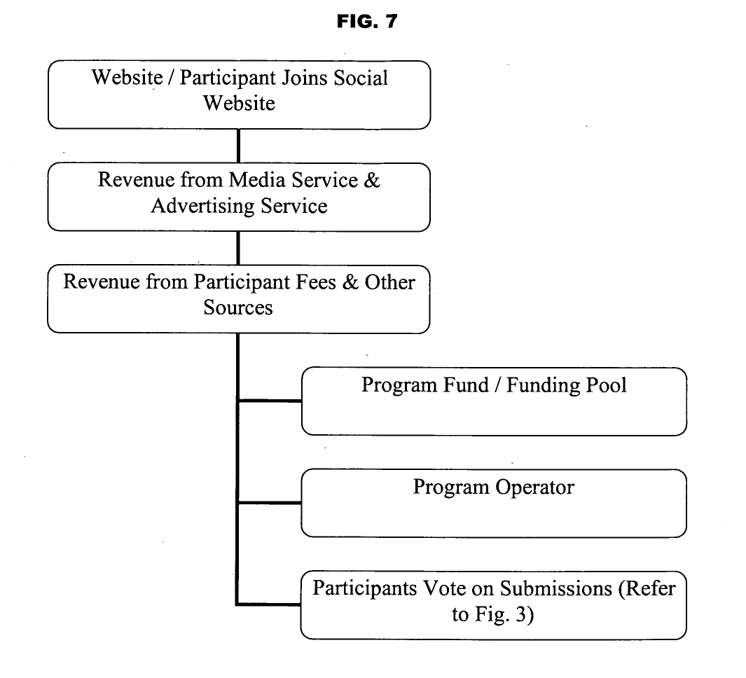

In another embodiment, money can be added to the program fund through the program's use of advertising or other media marketing related services. For example, the program's web site is a social web site that the participant joins for no fee, and each month a percentage or set amount of the advertising or other media marketing related services fees is added to the program fund. (Refer to FIG. 7).

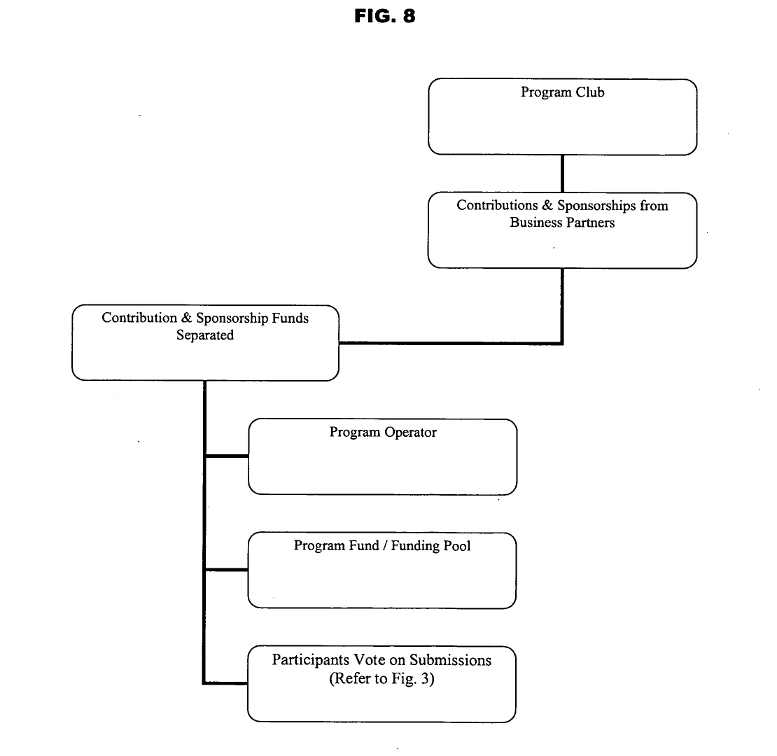

In another embodiment, money can be added to the program fund through contributions or sponsorships from the participant or the program business partner. For example, the program has no fee for the participant to join, but money is added to the program fund when the participant or the business partner makes a contribution. Money can also be added to the program fund from the business partner sponsorship fee. (Refer to FIG. 8).

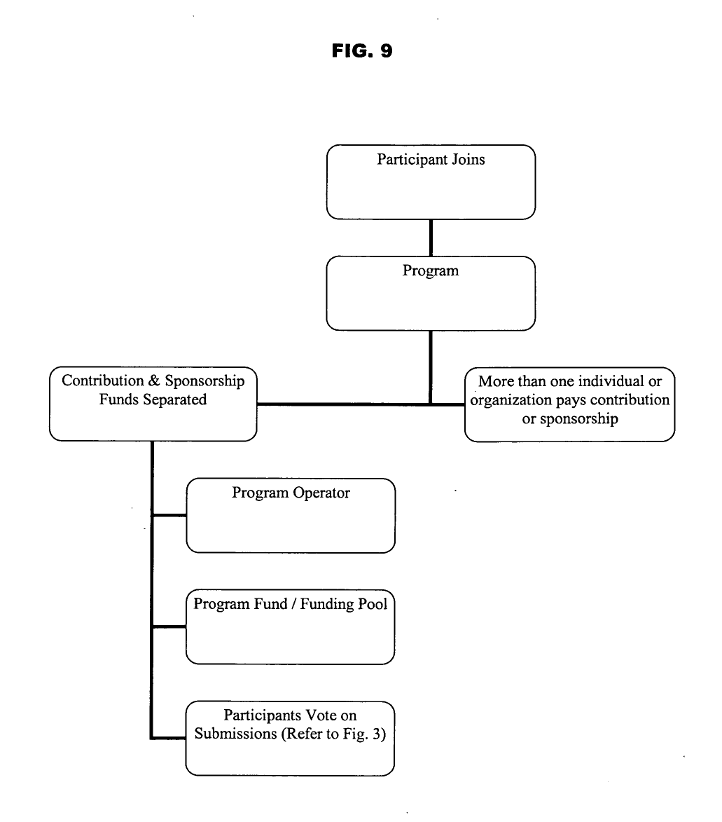

In another embodiment, money can be added to the program fund based on contributions or sponsorships of more than individual or organization who may be a participant. (Refer to FIG. 9). For example, three businesses partner together to create a program that will help market themselves. The three businesses agree to contribute $50,000. each month to the program fund.

In another embodiment, the program can have one or more categories which to classify a submission and have a winning vote getter in each category. The participant can be allowed one or more votes for each category.

In another embodiment, the participant can earn points which can be used toward gifts or purchases from the program business partner(s).

The present invention has many potential uses, preferably useful in a program with a specific theme or community of individuals that can help a certain group. For example, a program that is created to help movie producers get funding would attract participants interested in movies and the movie business. The following is some examples of programs that can use the present invention to raise funds:
1) A program with a general purpose to help fund charitable and non charitable needs.
2) A program with a specific purpose to help a certain need; for example, scholarships for education, medical, etc.
3) A program with a purpose to help fund needs related to religion or a specific religion.
4) A program to help fund home purchases or help with home loans.
5) A program to fund a Loan Fund to help people with different needs.
6) A program to help fund political organizations or politicians.
7) A program formed around a certain group of people; for example, wealthy individual; to have a high end exclusive program for raising and providing funds.
8) A program formed to help fund a gift program.
9) A program to create a business capital or business loan fund.
10) A program where multiple businesses join together to operate a program and contribute an amount to the fund which may be based on revenue.
11) A program operated by a television or video based producer to have audience join program and vote. The program fund is added to from advertising and related media revenue.
12) A charity operates a program as a way to help fund needs and raise funds for their organization.
13) A school or college operates a program to help raise funds for scholarship or school programs. Promote participation with alumni.
14) A community based program to raise funds for needs specific to the community.—
15) A municipality or government entity based program. Government entity contributes to a fund, and has taxpayers or citizens vote on submissions.
16) A program created to market business partners where the fund receives contributions based on sales to participants. Participants vote on submissions.
17) A program created to help fund films.
18) A program created to help fund theatrical plays.
19) A program created to help fund inventions.

Examples of parts of the Present Invention in action:

What follows is a perspective view of a method and system of raising and providing funds according to one embodiment of the present invention, and is not intended to limit the scope of the present invention.

### Example 1

### Program with a Membership Fee and Charitable Purposes

Participants become members of XYZ Charity Club, Program Operator. Members pay an annual fee of $19.00. Member benefits: $1 per month per member ($12 per year) goes in to a Fund which will be used to help different causes. The members review submissions requesting funding. The member will vote each month and have a say in how that money is disbursed. Each winner will receive some form of funding as long as they pass a vetting process. Any money from the fund not used on winners and other requests funded by funding committee that month will rollover to the next month.

Members and non members submit request for funding in different categories:
1. Scholarship—Students going to college or even a private High School. Not for an organizations scholarship fund—that should be in general
2. Medical—People in over their head in medical bills or things that are not covered. Not for research that should go in general
3. Dream Maker—Request that are for someone going for their dream—a business, a trip
4. General—Request of another nature. Should be used by non profit organizations looking for funding and other request.
5. Need—These are for smaller request for someone in need—food, home improvement, heat, etc.

Member and Non members submit request for funding via a communications network. Members will then be able to vote on the submissions they like. Members get one vote per category, plus may use Bonus Votes. Members will be eligible to receive Bonus Votes based on referring other members, contributions, spending with club business partners and other means determined by Program Operator.

Program Operator develops agreements with Business Partners to have Business Partners contribute a portion of revenue they receive from Participant purchases to the Fund. As an example, XYZ Charity Club has an agreement with ABC Business Partner that states 10% of each sale to an XYZ member gets added to the Fund. Participants purchase $1,000 from Business Partner in a month. $100 is added to the Fund from the Business Partner.

### Example 2

### Program with No Member Fee or Consumer Revenue, Funding Provided by Contributions

Multiple businesses in a community join together and form a Program and create a Program Operator. The Program is called Community Business Help Fund. Each business is a partner in the Program Operator, and pays a set sponsorship fee to the Program which is used to place an amount in the program fund. As an alternative, the sponsorship may be based on revenue or profitability. This money goes into the Program Fund. Participants join and/or register for the Program for free. Participants review submissions requesting funding, and vote. Winners receive funding.

### Example 3

### Program with No Member Fee or Consumer Revenue, Funding Provided by Participant Spending

A Program Operator named Business Marketplace recruits a plurality of businesses to be Business Partners. The Business Partners agree to contribute to the Fund a percentage of sales Business Partners make to Program Participants. Program Operator markets Business Partners via a web site. Participants join Program, make purchases, and earn money for the Fund. Participants vote on submissions requesting funding.

Of course, the various aspects of the embodiments shown in FIGS. 1-9 and described in the application may be mixed and matched as desired, where possible. Further, the present invention is not limited to only those embodiments shown.

I claim:

1. A computer-implemented method and system for raising funds using a participant vote based program via a communications network, comprising:
creating and providing an online program that more than one participant joins;
creating and providing a program fund comprising of currency, preferably money, that said currency is added to the fund in a method comprising at least one of a,b,c,d, e and f:
a) a formula, which can be a percentage, based on membership or non membership fees as paid by the participant in the program;
b) a formula, which can be a percentage, based on at least one of consumer revenue from participant purchases of a specific service or product, total consumer revenue from the participants in the program, profitability related to consumer revenue in the program, and consumer revenue related to purchases inside and outside the program;
c) a formula, which can be a percentage, based on advertising or other media related revenue from program or program operator web site;
d) a formula, which can be a percentage, based on participant purchases of goods or services through program business partners;
e) a formula, which can be a percentage, based on contributions or sponsorships from more than one program business partner or program participant;
f) a formula, which can be a percentage, based on contributions or sponsorships from more than one organization or individual who can be creators of the program;
providing a submission process wherein the participant or a potential participant has the opportunity to become a submitter, who request funding, by providing a submission template for inputting information into an electronic database to create an electronic web page to request funding;
providing a voting process wherein the participant can vote on the submission(s);
providing a disbursement process wherein the currency is disbursed from the program fund to the submitter(s) who are selected based at least partially on the results of the vote;
using a computer readable medium; the computer readable medium is a “non transitory” medium; can be accomplished via a communication network system, preferably internet based using an internet accessible device.

2. The method as in claim 1, further comprising of giving the program participant the opportunity to earn bonus votes which are additional votes; the bonus votes can be used in voting for a submission requesting funding.

3. The method as in claim 2, wherein the bonus votes can be earned or given based on any action allowable in the program.

4. The method as in claim 1, further comprising a voting cycle that can be on a periodic or continuous basis, preferably monthly.

5. The method as in claim 1, further comprising a program fund disbursement cycle that can be on a periodic or continuous basis, preferably monthly.

6. The method as in claim 1, further comprising at least partially determining money available for disbursement by separating the participant related fee or consumer income that is added to the program fund into time periods where the money or currency is available for disbursement, preferably twelve months.

7. The method as in claim 1, further comprising of disbursements from the program fund to the selected submitter can be in the form of a grant, loan, debt investment, equity investment, gift or donation and any allowable form of giving or investing money or other forms of currency; disbursement can be made with money or any other form of currency which can consist of goods and services, preferably in money, preferably in U.S. dollars.

8. The method as in claim 1, further comprising of providing funds for any type of need, request or project; available for any organization or individual need.

9. The method as in claim 1, further comprising of a system of paying commissions to affiliates.

10. The method as in claim 1, further comprising of showing a running vote total on the submission's web page or the program operator's web page.

11. The method as in claim 1, further comprising of allowing program participants to send money or help to the submitter, preferably directly through the submitter's submission page.

12. The method as in claim 1, further comprising a process of the participant learning how funds are used to help the selected submitter.

13. An internet accessible device, comprising: having access to a method for raising funds using a participant vote based program as claimed in claim 1, wherein the internet accessible device can communicate with the computer system hosting the program.

14. A method of giving, comprising: having access to a method for raising funds using a participant vote based program as claimed in claim 1, wherein the participant can monitor the effect of their giving or the program's funding of needs.
